(19) United States
(12) Patent Application Publication
(10) Pub. No.: US 2011/0279866 A1
(43) Pub. Date: Nov. 17, 2011

(54) METHOD OF PROCESSING A PRINT JOB

(76) Inventors: Paul F. Matheson, San Bruno, CA (US); I-Jong Lin, Half Moon Bay, CA (US)

(21) Appl. No.: 13/145,892

(22) PCT Filed: Jan. 23, 2009
(86) PCT No.: PCT/US2009/031893

§ 371 Date: Jul. 22, 2011

(51) Int. Cl. G06F 3/12

(52) U.S. Cl. 358/1.15

(57) ABSTRACT

The present invention is drawn to a method of processing a print job. The method includes encoding a print job post-print processing instructions. The method additionally includes printing the print job including the post-print processing instructions on a media substrate. The post-print processing instructions can be printed with a non-visible ink. The post-print processing instructions can be read, and the post-print processing can be performed according to the instructions.

### BACKGROUND

Processing instructions often tend to follow a print job in one of a few typical methods. Sometimes, written instructions are provided that are generally of the form of a printed page or pages. These printed pages are typically kept in close proximity to the print job and read by the user setting up the print job. On other occasions, stored instructions are provided in a database that can be accessed and associated with a print job through the use of an identification mark on print job packaging.

The volume of written instructions is often limited to an amount of information that is practicable to keep in printed form in proximity to the print job. Furthermore, written instructions can be lost or separated from the print job, increasing processing time and/or processing errors. Instructions accessed from a database run the risk of having the print job identification separated from the print job, thus precluding locating the processing instructions and furthering processing.

As a result, it would be useful to provide systems and methods for processing print jobs that reduce errors and provides an improvement over the known methods.

### BRIEF DESCRIPTION OF THE DRAWING

FIG. 1 is a flow diagram of a method of processing a print job in accordance with an embodiment of the present invention.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It must be noted that, as used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “non-visible ink” refers to ink that is generally not visible to an unaided human eye under normal lighting conditions, such as, e.g., sunlight and artificial indoor lighting. Non-visible ink can be responsive to any radiation outside of the visible light spectrum, and generally is responsive only to a select range of radiation. As the visible light spectrum is typically defined as including all wavelengths from about 380 nm to about 750 nm, any wavelength of energy above or below the range is non-visible radiation. Non-visible radiation includes “IR” or “infrared” and “UV” or “ultra violet”. Infrared radiation is that radiation with a wavelength greater than visible light. Specifically, IR includes radiation ranging from about 750 nm to about 1 mm. Conversely, ultra violet radiation is that radiation with a wavelength shorter than that of visible light. Typically, UV is defined as radiation with a wavelength ranging from about 1 nm to about 380 nm. UV radiation can be sub-divided into long wave or “black light” (about 315 nm to about or slightly greater than 380 nm), medium wave (about 280 to about 315 nm), and short wave (less than about 280 nm). Non-visible ink need not be in the range of light outside of the visible spectrum, as long as the markings are substantially invisible to the unaided human eye under normal lighting conditions. For example, any substantially “clear” markings can be used that are difficult to see with the human eye, but which a machine can read are included.

Additionally, as discussed herein, exposing a barcode or other printed non-visible instruction to some type of radiation or other method of retrieving information provided by the non-visible ink is meant to indicate exposure at a greater level to the non-visible radiation than is typically found in ambient light, or exposure to a system where information printed using the non-visible ink can be retrieved. For example, bringing the printed non-visible ink near a black light is included in exposing the encoded instructions to appropriate radiation, whereas taking the encoded instructions into the sunlight is not considered exposing to non-visible radiation, even though sunlight includes non-visible radiation.

The colorants used in non-visible ink are said to absorb non-visible radiation and shift the wavelength of the non-visible radiation to a reflected visible wavelength. Although this is the terminology used to explain the phenomena of exciting a colorant with non-visible energy and having the colorant emit a visible wavelength, it is understood that other explanations or descriptions are equally as probable and/or valid so long as it indicates that the colorant of the ink receives non-visible wavelength radiation and, as a result, emits or reflects visible wavelength energy. For example, it could be said that the colorants absorb non-visible radiation and emit a visible wavelength. Further, the colorants could be said to fluoresce a visible color upon receiving a non-visible radiation.

The terms “light” and “radiation” can be used interchangeably and mean energy in the form of waves.

As used herein, a plurality of items and/or steps may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, “JDF” is job definition format. Consistent with use in the art, it is an XML-based file format. Generally, JDF is considered an industry standard or at least a proposed industry standard. JDF includes a message description standard and message interchange protocol.

As used herein, the term “encode” and variations thereof, when used in the context of “encoding a print job,” refers to translating a message, generally instructions, into a computer-readable format and placing the translated message directly on the print job. This being said, whether encoded or merely written in plain language, at least a portion of the printed instructions remain on the actual media of the final print job.

With these definitions in mind, reducing the opportunity for user error in any process has the potential to greatly reduce processing errors, reduce unscheduled lag times, and overall produces better quality products. The present method reduces the opportunity for user error and also reduces the amount of operator training necessary to run a print process operation. Although the present method can be utilized to automate or semi-automate post-print processing, it can also be used independent of any automation. Automating a print processing operation, to some degree, can improve turn-around times, reduce necessary operator training, and reduce errors. As such, automation can be desirable in some embodiments. However, with the incompatible and unsupported nature of automated systems for print processing, as well as the high costs involved in replacing non-automated equipment, alternative less-automated processes can also desired in some circumstances.

As processing plants continue to grow and the physical distance between processing steps increases, or as the number of processing steps increase, the likelihood of job instructions being separated from a print job increases. Job instructions attached to a print job are inherently likely to become unattached to the job and disassociated from the job. This is because job instructions are not typically attached to a job continuously. Thus, as processing jobs are continuously fed through equipment, the likelihood of job instructions being associated with an incorrect job is also possible.

Simply printing instructions on the print job can also be undesirable. For example, it has been considered in the past that one method to improve job identification is to print an identification mark directly on the print job in a region to later be removed, i.e. instruction region to be cut away from the print job. Such identification markings can be verified with a central computer, and the job can be tracked. Unfortunately, the job tracking can add an additional unnecessary step (that of removing the identification marking from a finished print job) and, although the job tracking can be useful, any job instructions can be as easily separable from the tracked job as with a non-tracked job. Simply put, any markings on a finished print job that are not intentionally added for the sake of the print job, but rather are related to the processing of the print job greatly detract from the aesthetics and value of the finished product.

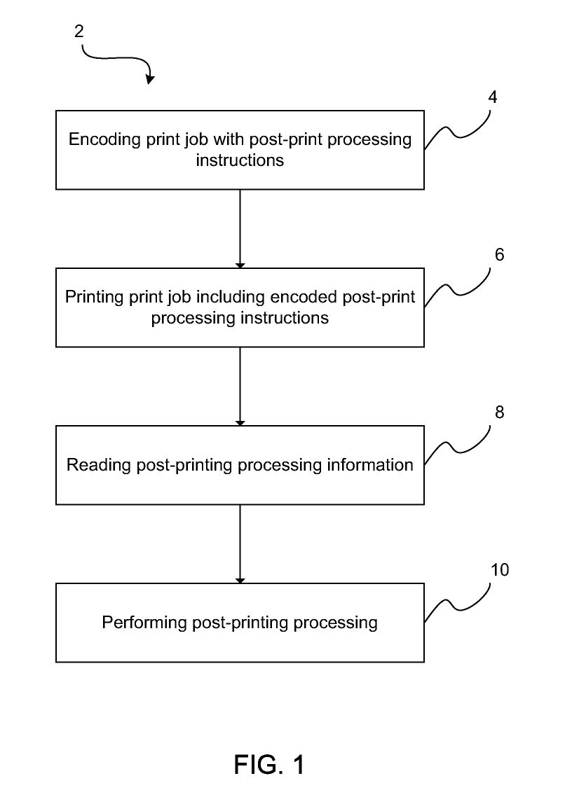

As such, the present disclosure is drawn to a method of processing a print job. As illustrated in FIG. 1, the method 2 includes encoding a print job with post-print processing instructions 4. The method additionally includes printing the print job, including the post-print processing instructions 6, on a media substrate. The post-print processing instructions can be printed with a non-visible ink in one embodiment. The post-print processing instructions can be read 8, and the post-printing processing can be performed according to the processing instructions 10. In one embodiment, the post-print processing instructions can be encoded in JDF.

As the print job instructions are printed 1) in an encoded manner, and 2) with non-visible ink, special readers can be used to read and interpret the job instructions. An optical scanner can be utilized to read the barcode or other form of information. Thus, either a scanner appropriate for reading the non-visible ink can be used, or a visible-light based optical scanner can be used in conjunction with a lighting or radiation source sufficient to reveal the non-visible ink encoded instructions. Alternatively, a modified optical scanner can be used that projects radiation sufficient to reveal the encoded instructions. In still another embodiment, a scanner that is more sensitive than the human eye can be used that is capable of detecting markings made by inks that have a clear appearance to the human eye, but which are readily readable by the scanner. In any of these or other similar embodiments, a mechanism can be used to read the barcode or other instruction markings, i.e. JDF information printed on the print job (which will not be cut away from the job).

The optical scanner and/or illumination device can be a hand-held device, mounted on a separate piece of equipment, mounted on the processing machine, or combination thereof. Depending on the non-visible ink, a UV-based radiation source or an IR-based light source can be utilized in certain embodiments. One example of a useful UV-based radiation source is a black light. By way of example, then, an optical scanner can be modified to include a black light. Alternatively, a black light can be utilized to illuminate the print job and reveal the barcode, which can be scanned with the optical scanner. Variations of use of illumination sources and scanning devices, either combined into a single device, or separately, would be apparent to one of ordinary skill in the art, and are contemplated by the present disclosure.

The scanning device can be associated with decoding the encoded post-print processing instructions, e.g., JDF information, on the print job itself. The decoded post-print processing instructions can be displayed for an operator or configured to automatically adjust and verify settings of a piece of post-printing processing equipment. Hand-held devices typically include a viewing screen where decoded instructions are shown. Where a print job includes a plurality of post-print processing steps, it is generally desired to scan the encoded information a number of times during processing at each appropriate step. Because the post processing instructions are printed directly on the print job, they cannot be lost and are always necessarily available to the operator when needed. Additionally, a print job can be scanned at any point in processing, including during a processing step, to verify that processing is according to instructions. Where each printed element of a print job can include the post-printing instructions, print jobs being separated, or disruptions during processing, such as loss of power, are less detrimental, and may even have no impact on the processing steps of the print job. A final scan of each outgoing product itself may optionally be used to verify that the processing is complete and accurate.

Encoding the print job with post-print processing instructions can occur at various places and various times with respect to printing of the print job. For example, the encoding of the print job can occur when the visible portion, i.e. standard printed information to be viewed by the target audience of the print job, to be printed is digitally created. Alternatively, the encoding of the print job can occur in a separate step previous to or after the creation of the visible printed portion.

In one embodiment, the method of processing a print job can include encoding the print job with instructions to use a printer-specific identification configured to print with a non-visible ink. Further, the method can include printing the encoded printer-specific identification with the non-visible ink. Many times, large print jobs are split into smaller jobs and sent to a number of printers. Generally, the desired product from each of these smaller jobs can be identical. Unless otherwise indicated, in the present context, “printers” can indicate separate printing equipment within a single printing company, separate printing companies, or a combination thereof. Printer-specific identification can include any marking associated with the particular printer that can be used to identify the particular printer responsible for the printing and/or post-print processing. Such identification can include, e.g., any one or combination of the name of the printer, date of printing, name of equipment or other equipment tracking information, job identification numbers, printer artwork or other identification mark, and any of the above encoded where possible. In one aspect, then, encoding the print job can additionally include encoding the print job with a print date or a lot number configured to be printed with the non-visible ink. By printing a printer-specific identification and/or a print date or lot number with the non-visible ink, the final products have traceability.

As a non-limiting example, consider a print job consisting of 800 fliers that are to be printed, trimmed, tri-folded, and placed in envelopes. If the job was a rush job and there were four separate print companies each with a capacity for 200 fliers by the deadline, then the print job can be split into smaller print jobs A, B, C, and D. In one aspect, the print job can be encoded with instructions to use a printer-specific identification configured to print with the non-visible ink. In the present example, the first print company, having smaller print job A, can be advised, upon looking at the digitized file to be printed, to enter the company's name and/or logo in a designated location, and that it is to be printed with non-visible ink. The entered information may or may not be encoded in a barcode. Alternatively or additionally, the printer having smaller print job A can add a date of printing or other meaningful date or a lot number providing internal tracking, to the non-visible design aspect of the print job prior to printing. Upon printing, the smaller print job A can include additional instructions in the non-visible image instruction portion, providing post processing instructions as it relates to finishing the task by the printer. Thus, the printed processing instructions (typically provided by the party ordering the job) and information added by the printing company could both be included on the finished product. When all print jobs are complete and the products are optionally combined and/or distributed, should there be any problems or reason to locate the exact printer responsible for a single flier, viewing the non-visible image will reveal, either to the eye, or with additional optical scanners, which of the four printer companies were responsible for the flier. To be clear, the information provided by the printer to be printed in non-visible ink can be encoded or plainly readable using appropriate equipment. The information provided by the printer can be included with the encoded post-print processing instructions, can be a separate encoded mark, or can be printed directly on the print job.

The step of encoding a print job with post-print processing instructions can occur at any point prior to printing the post-print processing instructions on the media substrate. In one aspect, the encoding is carried out at the time the print job is generated. In this scenario, the encoding is generally completed and/or verified by the person responsible for approving the final digital copy of at least the print aspects of the print job. Alternatively, in one aspect, the encoding is carried out after the print job is generated. Such is the case, for example, wherein a contract printer encodes the post-print processing instructions prior to releasing the print job to be printed. In a further embodiment, post-print processing instructions can be added to the print job by an operator of the printing step. Depending on the printer set-up, it can be useful for the printer operator to add information to be encoded.

As will be apparent to one skilled in the art after considering the present disclosure, there are a number of post-printing processing steps. Any print job can include any one or plurality of post-printing processing steps. Non-limiting examples include cutting or trimming, stitching, labeling, binding, folding, collating, punching, drilling, preparing for mailing, and combinations thereof. In one aspect, the post-printing processing can include treating the media substrate following printing. Such treatment can occur prior to any other post-printing processing steps, in-between such steps, or after any post-printing processing steps. Alternatively, such treatment can be the only type of post-printing processing carried out for the print job. Non-limiting examples of treating the media substrate include lamination, varnishing, chemically treating a surface, fixing, etc., and combinations thereof. It should be noted that post-printing processing, and particular media substrate treatment, can be carried out on all of the media, on select portions of the media, and/or on select portions of each media, as instructed by the post-print processing instructions encoded on the media used for the print job. For example, only ½ of the job may be punched. In another example, only a select upper right corner of each printed paper may be varnished. Many variations of treatment and the uniformity of treatment are contemplated herein.

The media substrate can be any number of materials capable of accepting a printed image, including the encoded post-print processing instructions and source information in printed form using non-visible ink. In one aspect, the media substrate can include paper. The paper can be of any size or shape, and can be pre-trimmed or trimmed post-printing, where desired. The print job itself can be monochrome, black and white, or multi-colored. The print job can optionally include regions or areas that include more than one coloring selected from monochrome, black and white, and multi-colored. For example, a book or booklet can be produced including a multi-colored cover page and/or multi-colored picture pages and multiple text pages printed in black and white. By encoding the information in printed form using non-visible ink directly on the media, print jobs utilizing the present method are not limited to specific media. For example, a print job can be printed, along with print instructions, on standard paper. There is no need for paper modified with embedded electronics, attached optics, or any media modification other than the printed processing instruction and/or other printing source information.

Preferably, the media substrate and the ink used to print the print job, including the non-visible ink, are compatible with one another. Various treatments are possible for substrates, and various additives and ink formulations are available for improving compatibility. Generally, any colorant capable of absorbing non-visible radiation and reflecting a visible wavelength can be included in as a colorant in the non-visible ink as described herein. Example colorants include ultra violet pigments and infrared pigments. Non-limiting examples of ultraviolet pigments include Invisible Red S, Invisible Blue S, Invisible Cyan S, Invisible Blue E, Invisible Red E, Invisible Red R, Invisible Green R, and Invisible Blue R (from Glowbug); ADA4604, ADA4619, ADA4605, ADA4607, ADA4628, and ADA4625 (from H. W. Sands Corp.); IPO-19, IPO-18, and IPO-13 (from DayGlo Color Corp.); SPF-0008, SPF-0013, SPF-0018, SPF-1100, SPF-1200, SPF-1300, SPF-1400, SPF-1800, SPF-1900, SPF-2300, SPF-2100, SPF-2800, and SPF-3100 (from Spectra); Pigment UVR, and Pigment UVG (from StarDust Materials); and Blue CD164, Blue CD165, Green CD163, Green CD145, Red CD106, Red CD105, and Red CD120 (from Honeywell). Non-limiting examples of infrared pigments include UC-1 (from Glowbug); ADB5350, ADB8800, and ADB4888 (from H.W. Sands Corp.), and Pigment Z, Pigment K, and Pigment S (from StarDust Materials). These colorants, in the quantities used, can be visually imperceptible (substantially invisible) under ambient light.

As noted, in one embodiment, the print job instructions are encoded in JDF, or job definition format. This format is useful in that it is well recognized and requires minimal equipment modification for compatibility. JDF information is an XML, or extensible markup language, format used for a job ticket. Post-print processing instructions can be encoded in any manner that can function as printed directly upon the media of the print job. In one aspect, the post-print processing instructions can be encoded as a barcode. Generally, barcodes include a series of lines, and are fairly recognizable. However, the design and amount of data included in barcodes continues to expand, and any barcode format is contemplated herein. To reiterate, any barcode design can be utilized, including but not limited to 1-dimensional and/or 2-dimensional barcodes. More than one barcode can optionally be utilized, if necessary or desired.

There are a number of advantages for encoding job-specific data on the printed sheet. Equipment operators can easily access or input data at any point during processing. Companies with old equipment can at least partially automate production without expensive equipment replacement upgrades. Jobs can optionally be tracked as they move through production. Customers can identify where a particular job was printed based on the data encoded on the document. The encoded non-visible instructions provide a level of document security, as print jobs can be easily identified and tracked. Thus, the likelihood of forgery is reduced. Easy to use scanners reduce the amount of training required for employees. Any scanner used can optionally be configured to gather and send data in real time, thus enabling reliable job tracking. Structure and compatibility issues are reduced or eliminated by utilizing the recognized form of JDF. The printed instructions can be used to evaluate an end product. Further, the instructions, printed in non-visible ink, do not require physical removal from the finished product, as they are not detectable to the human eye.

If a higher degree of automation is desired for older equipment, post-print processing instructions can be sent to a “bridge” server. The bridge server can bridge the gap between the automation system and older equipment that cannot be otherwise automated. Post print processing equipment can scan and acquire post print processing instructions using scanners, as previously discussed. The barcodes and optionally other job-specific information can be printed on the actual printed material using inks that are only visible under non-visible radiation. Automated equipment can read this information and perform their functions; semi-automated or manual equipment must be configured by the operators. Operators gather the required information by using a radiation source and an optical scanner, such as a UV lamp and a barcode scanner (either separately, or as a modified single gadget). These scanners would read the data from the printed sheet and display this information to the operator. In the case of post-print processing instructions encoded in JDF, for example, the bridge server, receives scanned data and operator inputs, converts the data into JDF or JMF (job messaging format) and can send this data to the JDF MIS (job definition format management information system) server or the JMF controller. Equipment operators would only need the scanner, if modified, or scanner and radiation source. With this system, they can access information as well as input start/stop times, status, results, etc.

Conventional printers such as sheet-fed or web presses can generally print the post-print processing instructions on the media using ink jet print heads. Such printing can be simultaneous to the printing of the print job. In such cases, the non-visible ink can be included in the system using an extra ink pen. Alternatively, Indigo digital presses, for example, have UV ink that can be applied as a 5^{th}, 6^{th}, or 7^{th} color. Still further, the printing of the encoded post-print processing instructions can be a separate printing step following the printing of the print job. The encoded post-print processing instructions are generally printed on the main printed portion of each individual product printed. For example, in a book production, each page of the book could include encoded post-print processing instructions in non-visible ink. The hard-back binding of the book, however, which may not be printed, might not include encoded information.

Although much discussion has been spent on a method of processing a print job, it should be understood that the discussion is likewise applicable to a digital print job file, and associated systems. In one aspect, a digital print job file can include a visible print component, and two non-visible print components. One of the non-visible print components can include post-print instructions encoded as a barcode or other instruction information. The second non-visible print component can be connected to or associated with a specific printer. Each of the visible and non-visible print components can be configured for simultaneous printing on a single media substrate.

As previously noted, there are many benefits to utilizing the present method and associated systems and job files. Production workers need to focus on doing their job and getting the material to the next stage in production. By giving the worker a handheld scanner, they can perform and document their work from any location. Optionally, this data is instantly available for tracking the job status. The upgrade and maintenance to allow tracking is relatively simple and fairly inexpensive. A technical support department only needs to support one or two servers that can be placed in a controlled environment, instead of supporting dozens of workstations in an uncontrolled manufacturing environment. The inclusion of instructions directly on a print job, yet in a way that is not apparent to a casual observer, eliminates the likelihood of separating instructions from a print job. Thus, print jobs can be processed at a higher level of proficiency and without unnecessary time-lags spent hunting down instructions. Additionally, the resulting products are more likely to be produced according to the instructions.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

1. A method of processing a print job, comprising:
encoding a print job with post-print processing instructions;
printing on a media substrate the print job including the post-print processing instructions, said post-print processing instructions printed with a non-visible ink;
reading the post-print processing instructions; and
performing the post-printing processing according to the post-printing processing instructions present on the media substrate.

2. A method as in claim 1, wherein the post-print processing instructions are encoded in JDF.

3. A method as in claim 1, wherein the reading includes using an optical scanner.

4. A method as in claim 1, wherein the reading includes using black light.

5. A method as in claim 1, wherein the encoding of the print job further includes encoding the print job with instructions to use at least one of printer-specific identification, print date, and lot number, each configured to print with a non-visible ink.

6. A method as in claim 1, wherein the post-printing processing includes at least one process selected from the group consisting of cutting, stitching, labeling, binding, folding, collating, punching, drilling, trimming, preparing for mailing, and combinations thereof.

7. A method as in claim 1, wherein the media substrate includes paper.

8. A method as in claim 7, wherein the post-printing processing includes coating or treating the media substrate before or after printing.

9. A method as in claim 8, wherein the coating or treating of the media substrate includes lamination, varnishing, chemically treating a surface, or combinations thereof.

10. A method as in claim 1, wherein the post-print processing instructions are encoded as a barcode.

11. A method as in claim 10, wherein the barcode is a 1-dimensional barcode.

12. A method as in claim 10, wherein the barcode is a 2-dimensional barcode.

13. A method as in claim 1, further comprising tracking the print job status by relaying at least a portion of the read post-print processing instructions to a central server.

14. A method as in claim 1, wherein the post-print processing instructions remain on a final product generated on the media substrate.

15. A method as in claim 1, wherein the encoding is carried out at the time the print job is generated.

16. A method as in claim 1, wherein the encoding is carried out after the print job is generated.

17. A method as in claim 16, wherein post-print processing instructions are added to the print job by an operator of the printing step.

18. A digital print job file, comprising:
a visible print component;
a non-visible print component including post-print instructions encoded as barcode; and
a non-visible print component connected to a specific printer,
wherein each of the visible and non-visible print components are configured for simultaneous printing on a single media substrate.

19. A file as in claim 18, wherein the media substrate includes paper.

20. A file as in claim 18, wherein the post-print processing instructions are encoded in JDF.
